(19) United States
(12) Patent Application Publication
(10) Pub. No.: US 2008/0225048 A1
(43) Pub. Date: Sep. 18, 2008

(54) CULLING OCCLUSIONS WHEN RENDERING GRAPHICS ON COMPUTERS

(75) Inventors: Soumyajit Deb Bijankumar, Bangalore (IN); Ankit Gupta, Delhi (IN)

Correspondence Address: PERKINS COIE LLP/MSFT, P. O. BOX 1247, SEATTLE, WA, 98111-1247, US

(73) Assignee: Microsoft Corporation, Redmond, WA (US)

(21) Appl. No.: 11/686,737

(22) Filed: Mar. 15, 2007

(51) Int. Cl. G06T 15/40

(52) U.S. Cl. 345/421

(57) ABSTRACT

An occlusion culling system is provided. In various embodiments, the occlusion culling system can combine a hierarchical object space tree with image space occlusion queries to reduce the number of occlusion queries that are issued to a GPU. In various embodiments, the occlusion culling system can enable culling of dynamic objects, identification of sections of a hierarchical tree representing objects to be rendered, and continuous refinement of the object hierarchy. The occlusion culling system can perform further refinements to reduce the number of occlusion queries that are issued to the GPU during rendering of computer graphics.

### BACKGROUND

Computer systems can be employed to display various types of graphics, such as three-dimensional graphics. Users may employ graphics systems to generate and display complex graphical scenes. These graphics systems employ what has been termed a “graphics pipeline” or “rendering pipeline.” The graphics pipeline generally accepts a representation of a three-dimensional scene (“model”) containing objects and provides (“renders”) a two-dimensional “raster image” as output that is suitable for displaying on a screen, printing on paper, or outputting on some other two-dimensional surface.

The stages of the graphics pipeline are generally (1) modeling transformation, (2) lighting, (3) viewing transformation, (4) projection transformation, (5) clipping, (6) rasterization, (7) texturing, and (8) display. Each of these stages is briefly described as follows. During the modeling transformation stage, objects to be rendered in a scene are input as “geometric primitives,” such as by using a three-dimensional, “object space” coordinate system. During the lighting stage, the scene is “lit” according to locations of light sources, reflectivity of the objects, and so forth. Graphics systems can also compute lighting during rasterization. During the viewing transformation stage, the objects are transformed from object space coordinates into a three-dimensional coordinate system based on a viewpoint. The viewpoint is the position of the observer or camera in relation to the three-dimensional coordinate system. During the projection transformation stage, objects are transformed from the three-dimensional coordinate system into a two-dimensional space. During the clipping stage, objects that would be rendered outside a viewing frustum are caused to be ignored from the rest of the graphics pipeline's processes. The viewing frustum (also “view frustum” or simply “frustum”) is the region of the three-dimensional space that contains objects that will be rendered (e.g., displayed on a computer screen or printed on paper). The frustum is the portion of a cone or pyramid between two planes, such as planes that are parallel to the base of the pyramid or cone formed between a viewpoint (e.g., “camera”) and the farthest object from the viewpoint. Objects that would be rendered outside the viewing frustum can be ignored because they would not be displayed or printed. During the rasterization stage, the two-dimensional image is converted into a raster format (e.g., having pixels). During the texturing stage, textures and colors can be added to the two-dimensional image. During the display stage, the image is displayed or printed. Because the graphics pipeline is computationally complex, various techniques have been implemented to reduce computational burden to enhance performance, both in software and in hardware.

One hardware technique that is used to enhance performance is to employ one or more graphics processing units (GPUs). Over the years, the rendering capabilities of computers have increased substantially. By some estimates, the rendering power of computer graphics cards employed by home computers has doubled every year. With the advent of inexpensive computer systems with GPUs, pixel processing power that was previously limited to supercomputers has found its way into modern home computers. Modern GPUs are generally coupled to graphics cards or computer motherboards and can enable much higher response for graphics operations than conventional central processing units.

As a result of these hardware improvements, virtual environments that achieve cinematic realism are finding their way into computer games and interactive applications that make intensive use of computer graphics. Some of this technology has even found its way into video game consoles, such as MICROSOFT's XBOX 360, that enable the general public to view very high-end graphics. Computer graphics applications employ many polygons to draw objects in scenes. As an example, a scene that is to be drawn may contain many thousands of polygons. Because rendering polygons can take time because of a large number of mathematical computations, graphics applications sometimes employ a “polygon budget” that limits the number of polygons so that rendering the scene does not take too long. Although the texturing and shading capabilities of games and applications have grown tremendously, there has not been a commensurate increase in the “polygon budgets” of these applications because of computational inefficiencies.

A large body of research in the computer graphics area focuses on efficient rendering. Many of these techniques attempt to minimize the number of primitives pushed into the graphics pipeline by utilizing visibility culling, levels of detail (LOD), or other techniques. Visibility culling techniques remove sections of the model that would be invisible from the current viewpoint. LOD-based techniques reduce the number of primitives in the model. Conventional high-performance systems utilize a combination of both visibility culling and LOD techniques to reduce the number of primitives that are rendered. Visibility culling can be further classified into view frustum culling and occlusion culling. View frustum culling prevents objects outside the view frustum from being processed. Occlusion culling prevents the processing of objects that are inside the view frustum but are occluded (e.g., hidden) by other objects in the line of sight between the current viewpoint and the objects. As an example, when an object occludes another object such that the other object is invisible, the other object does not need to be processed and so processing efficiency is increased. In various embodiments, view frustum culling can be optimized by using various optimization techniques, such as techniques described in Assarsson, U. & Moller, T., “Optimized View Frustum Culling Algorithms for Bounding Boxes,” J. Graph Tools 5, 1, 9-22 (2000), which is hereby incorporated herein by reference in its entirety.

Occlusion culling can be classified into two categories based on when the occlusion occurs. “Offline” techniques perform occlusion culling early in the rendering pipeline and employ binary space partitioning (BSP) trees in which a potentially visible set (PVS) of objects is determined for a static subdivision of the scene into visible and invisible objects. A BSP tree represents a recursive, hierarchical partitioning, or subdivision, of an n-dimensional space into convex subspaces. BSP tree construction is a process that takes a subspace and partitions it by any hyperplane that intersects the interior of that subspace. The result is two new subspaces that can be further partitioned recursively. Although these offline techniques identify visible objects for rendering at runtime, they generally function with an original configuration of the scene and do not support dynamic modification of scenes, such as during animation. Computing the PVS is also computationally expensive. Many of these problems can be avoided if occlusion culling is performed during “online” rendering that performs occlusion culling later in the rendering pipeline.

Online occlusion culling algorithms generally combine hierarchies in the object space (e.g., those hierarchies that are assembled before the modeling transformation stage) with an optimized occlusion representation in the image space (e.g., after the projection transformation stage). These algorithms can be classified broadly into two categories: (1) software-based occlusion culling techniques and (2) hardware-based occlusion culling techniques. Software-based occlusion culling techniques typically read the frame buffer or depth buffer associated with GPUs (or maintain their own software depth buffer) and then detect occlusions based on information stored in these buffers. A frame buffer stores a rasterized image. A depth buffer stores indications of the relative distances between objects and a viewer (e.g., camera). Hardware-based methods utilize GPU occlusion queries instead of depth buffer reads. Occlusion query processing on GPUs used to be slow and hence software methods were preferred. Because of hardware improvements in GPUs, occlusion queries have become fast enough to be usable in applications that employ graphics systems. With currently available GPUs, occlusion queries are many times faster than software reads of buffers, which are limited by the bandwidth of the host system's bus. Software reads suffer from performance degradation with increasing viewport resolutions because a large amount of data needs to be transferred to the host system's central processing unit (CPU). Thus, software-based occlusion culling can be less efficient than hardware-based occlusion culling in modern computing systems having GPUs that provide fast occlusion query features. However, a graphics system that issues too many occlusion queries to GPUs can also cause a significant slowdown in the graphics pipeline because the GPUs could be slower at performing other graphics-related tasks.

### SUMMARY

An occlusion culling system is provided. The occlusion culling system can combine a hierarchical object space tree with image space occlusion queries to reduce the number of occlusion queries that are issued to a GPU. The occlusion culling system can enable culling of dynamic objects, identification of sections of a hierarchical tree representing objects to be rendered, and continuous refinement of the object hierarchy. The occlusion culling system can receive a hierarchical structure (“tree”) in the object space. Each node of the tree represents a particular section of a model (e.g., objects) in space. The occlusion culling system can then subdivide the space into further partitions depending on objects associated with each node of the tree. Seen from a viewpoint (e.g., camera location), the occlusion culling system can divide the scene into objects that are inside the view frustum and those that are outside. The occlusion culling system can then perform further refinements to reduce the number of occlusion queries that are issued to the GPU.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIGS. 1A-1B are block diagrams illustrating components employed by the occlusion culling system in various embodiments.

FIG. 2 is a flow diagram illustrating a handle_movement routine invoked by the occlusion culling system in some embodiments.

FIG. 3 is a flow diagram illustrating a handle_event routine invoked by the occlusion culling system in some embodiments.

FIG. 4 is a flow diagram illustrating a render routine invoked by the occlusion culling system in some embodiments.

FIG. 5 is a flow diagram illustrating an update_frustum routine invoked by the occlusion culling system in some embodiments.

FIG. 6 is a flow diagram illustrating an update_object_frustum routine invoked by the occlusion culling system in some embodiments.

FIGS. 7-8 are flow diagrams illustrating an update_OC routine invoked by the occlusion culling system in some embodiments.

FIG. 9 is a flow diagram illustrating a collect_results routine invoked by the occlusion culling system in some embodiments.

FIG. 10 is a flow diagram illustrating a refine_hidden routine invoked by the occlusion culling system in some embodiments.

FIG. 11 is a flow diagram illustrating a refine_out routine invoked by the occlusion culling system in some embodiments.

FIG. 12 is a data diagram illustrating a hierarchical representation of data the occlusion culling system may employ in some embodiments.

FIG. 13 is a data diagram illustrating lists the occlusion culling system may employ in some embodiments.

### DETAILED DESCRIPTION

An occlusion culling system is provided. In some embodiments, the occlusion culling system combines a hierarchical object space tree with image space occlusion queries to reduce the number of occlusion queries that are issued to a GPU. In various embodiments, the occlusion culling system can enable culling of dynamic objects, identification of sections of a hierarchical tree representing objects to be rendered, and continuous refinement of the object hierarchy. In various embodiments, the occlusion culling system receives a hierarchical structure (“tree”) in the object space. Each node of the tree represents a particular section of a model (e.g., objects) in space. The occlusion culling system can then subdivide the space into further partitions depending on objects associated with each node of the tree. Seen from a viewpoint (e.g., camera location), the occlusion culling system can divide the scene into objects that are inside the view frustum and those that are outside. If an object associated with a node intersects the view frustum, the occlusion culling system analyzes the node's descendants to locate either (1) leaf nodes that intersect the view frustum or (2) nodes that are completely inside or outside the view frustum. The occlusion culling system can further divide nodes that are inside the view frustum into those that are hidden or visible. If a node is visible and it is not a leaf node, then some of its children may be hidden. Thus, if a non-leaf node is visible, the occlusion culling system can analyze descendants of the non-leaf node to locate descendant nodes that are hidden or leaf nodes that are visible. Leaf nodes in the object tree may point to geometry that is used to render objects and hence are directly drawn on the frame buffer. Thus, the visibility status of a scene can be modeled as a “graph cut” of the object tree, which is referred to herein as a “visibility cut.” A node of the visibility cut can have one of the following statuses:
1. “out” when it is associated with an object that is outside the view frustum;
2. “visible” when it is a leaf node that is associated with a visible object that is rendered; and
3. “hidden” when it is associated with a hidden object, whether or not the node is a leaf node.

All other nodes of the tree are marked as “no list” because they do not contribute to the view status of the associated object. In some embodiments, a node may be marked as “intersecting” when it intersects the view frustum.

The object culling system can update the visibility cut for frames (e.g., during an animation sequence) by efficiently making full use of the object hierarchy with spatial and temporal coherency. As an example, the occlusion culling system can employ a time bounding volume to determine when to next analyze an object. Time bounding volumes are described in further detail below. In some embodiments, the object culling system may update the visibility cut for every frame during the animation sequence.

The occlusion culling system incorporates various optimization techniques to enhance performance. An “occlusion refinement” optimization technique involves spatial coherency in the object hierarchical tree. Using this technique, the occlusion culling system marks an object associated with a node as “hidden” when objects associated with all of its children nodes are marked as “hidden.” This avoids the need to issue occlusion queries for the children nodes. However, this may not be done when the object associated with the parent node is visible but the objects associated with the children nodes are hidden.

The occlusion culling system may also employ a “frustum refinement” optimization technique. In this technique, the occlusion culling system may treat a node's parent as having an “out” status when the node's siblings are all outside the view frustum and the node's parent is also outside the view frustum. By doing so, the number of frustum updates the occlusion culling system computes may be reduced.

The occlusion refinement and frustum refinement techniques can be performed at various time intervals. Because the refinement techniques can impose their own overhead, the time intervals can be optimized. The occlusion refinement technique can be applied when objects retain their “visible” status, when objects retain their “hidden” status for a period of time, etc.

The occlusion culling system supports dynamism, which occurs when objects are dynamic (e.g., because they move, morph, etc.). To handle dynamism, the occlusion culling system provides a discrete simulation model in which movements of objects or the frustum are treated as events. Each event indicates whether the event is associated with the viewer (e.g., camera) or an object, and various motion-related parameters. In this discrete event simulation model, each frame is considered as a time unit. When an object moves, the movement causes an interrupt that the occlusion culling system handles. During handling of the interrupt, the occlusion culling system analyzes motion, translational velocity, and angular velocity associated with the moving object. The occlusion culling system maintains a “dirty bit” (e.g., a flag) associated with each moving object. When an object moves, the occlusion culling system sets its dirty bit. The dirty bit indicates that the object has moved but its position has not been recalculated since the movement. The object may also have an associated time bounding volume (TBV). The TBV indicates the time span within which an object may not need to be re-analyzed. After the time span expires, the object may need to be re-analyzed for its position, orientation, motion parameters, etc. After completing this analysis, the occlusion culling system unsets the dirty bit. By avoiding this analysis for every frame, the occlusion culling system reduces computations.

In some embodiments, the occlusion culling system handles transparent objects differently than non-transparent objects because transparent objects generally do not occlude other objects. The occlusion culling system may first render opaque objects. The remaining objects may then be rendered in order from the farthest to the closest in relation to the viewpoint. When rendering transparent objects, the occlusion culling system may not update the depth buffer because it renders transparent objects in order.

In some embodiments, the occlusion culling system may apply LOD techniques when rendering objects. As an example, objects that are farther from the viewpoint may receive less detail than objects that are closer. The occlusion culling system employs results from the occlusion queries it issues to determine the appropriate LOD for an object. When the object displays a large number of pixels, the LOD is increased. Thus, the occlusion culling system may determine whether some threshold number of pixels would be rendered to increase or decrease detail.

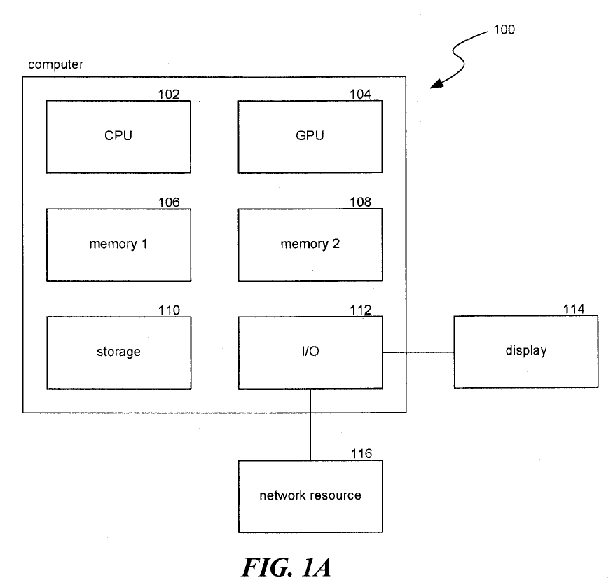

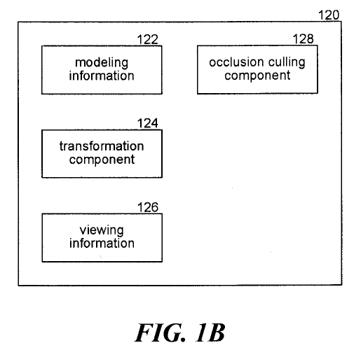

The occlusion culling system will now be further described with reference to the Figures. FIG. 1A is a block diagram illustrating components employed by the occlusion culling system in various embodiments. The occlusion culling system includes a computing system, such as a computer 100. The computer can be any general purpose or special purpose computing device. The computer can include one or more central processing units (CPUs) 102. The computer can also include one or more GPUs 104. The CPUs and the GPUs may be connected to one or more memories, such as memories 106 and 108. In various embodiments, the CPUs and the GPUs may have separate memories. Alternatively, the CPUs and the GPUs may share a common memory. The computer may also have a storage component 110 and an input/output component 112. The storage component can be a remote storage (e.g., a server) or a local storage (e.g., a drive). The input/output component may enable the computer to communicate with other components or devices, such as a display 114 and a network resource 116.

The computing devices on which the occlusion culling system operates may include one or more CPUs, memories, input devices (e.g., keyboard and pointing devices), output devices (e.g., display devices), storage devices (e.g., disk drives), and network devices (e.g., network interfaces). The memory and storage devices are computer-readable media that may store instructions that implement the occlusion culling system. In addition, the data structures and message structures may be stored or transmitted via a data transmission medium, such as a signal on a communications link. Various communications links may be employed, such as the Internet, a local area network, a wide area network, or a point-to-point dial-up connection.

The occlusion culling system may use various computing systems or devices, including personal computers, server computers, hand-held or laptop devices, multiprocessor systems, microprocessor-based systems, programmable consumer electronics, electronic game consoles, network PCs, minicomputers, mainframe computers, distributed computing environments that include any of the above systems or devices, and the like. The occlusion culling system may also provide its services to various computing systems, such as personal computers, cell phones, personal digital assistants, consumer electronics, home automation devices, and so on.

The occlusion culling system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

FIG. 1B is a block diagram illustrating components employed by the occlusion culling system in various embodiments. The occlusion culling system 120 includes modeling information 122, a transformation component 124, viewing information 126, and an occlusion culling component 128.

The modeling information includes information that can be employed to create a scene of the objects that are to be displayed. As an example, the modeling information can include information pertaining to buildings, roads, bridges, fountains, and other objects associated with an urban area. The modeling information can include information that can be used to display objects and derive relationships between the objects.

The transformation component can transform data from one form into another. The transformation component can transform modeling information into a geometric model. A geometric model is a geometric set of descriptions of objects and can be represented using scalars, vectors, etc. Graphics systems commonly employ geometric models to represent object surfaces, such as by employing meshes of triangles. Upon receiving an identified viewpoint, the transformation component can also transform the geometric model into viewing information that can be employed to display objects.

Viewing information is information that the occlusion culling system, or indeed other graphics systems, can use to render information visually, such as on a computer display or printer. The viewing information is sometimes represented in screen or printer coordinates (e.g., in image space), such as pixels.

The occlusion culling component applies various algorithms to identify occluded objects. It may also efficiently issue occlusion queries to one or more GPUs.

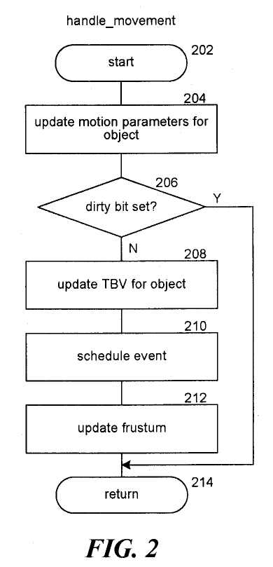

FIG. 2 is a flow diagram illustrating a handle_movement routine invoked by the occlusion culling system in some embodiments. The occlusion culling system can invoke the handle_movement routine when an object moves, such as during an animation sequence. The routine begins at block 202. At block 204, the routine updates motion parameters for the object that moves. As an example, the routine may update information relating to the direction and the speed at which the object is moving. At decision block 206, the routine determines whether a dirty bit is set. The dirty bit indicates whether or not the frustum position or parameters relating to the object need to be analyzed. If the dirty bit is set, the routine continues at block 214, where it returns. Otherwise, the routine continues at block 208. At block 208, the routine updates the time bounding volume (TBV) for the object. Techniques for updating the TBV based on an object's motion are described in Sudarsky, O., & Gotsman, C., “Dynamic Scene Occlusion Culling,” IEEE Transactions on Visualization and Computer Graphics V, 1, 13-29 (1999), which is hereby incorporated herein by reference. TBVs enable graphics systems to efficiently handle dynamic objects because they reduce computations during the time the dynamic objects remain within the TBV. Otherwise, the computations may need to be performed for every frame. At block 210, the routine schedules an event. As an example, the routine schedules an event so that the moving object can be rendered again at some later time after the object moves. At block 212, the routine updates the frustum. As an example, the routine can update the frustum when the position of the camera changes. The routine returns at block 214.

Those skilled in the art will appreciate that the logic illustrated in FIG. 2 and described above, and in each of the flow diagrams discussed below, may be altered in a variety of ways. For example, the order of the logic may be rearranged, substeps may be performed in parallel, illustrated logic may be omitted, other logic may be included, etc.

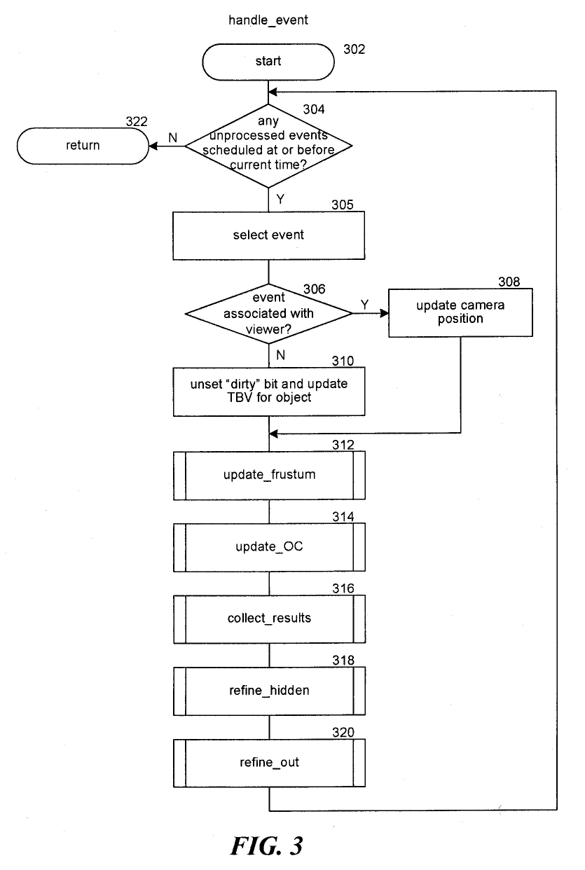

FIG. 3 is a flow diagram illustrating a handle_event routine invoked by the occlusion culling system in some embodiments. The handle_event routine handles previously scheduled events, such as events scheduled by the handle_movement routine described immediately above in relation to FIG. 2. The routine begins at block 302. At decision block 304, the routine determines whether there are any unprocessed events that were scheduled for handling at or before the current time. If there are no such events, the routine returns at block 322. Otherwise, the routine continues at block 305.

At block 305, the routine selects an event from the list of unprocessed events. The list of unprocessed events can be stored in various data structures, such as an array, linked list, queue, stack, and so forth.

At decision block 306, the routine determines whether the selected event is associated with the viewer. When an event is associated with the viewer, it may impact the rendered scene. If this is the case, the routine continues at block 308. Otherwise, the routine continues at block 310. At block 308, the routine updates the camera position. The routine then continues at block 312. At block 310, the routines unsets a dirty bit and updates the TBV for the object associated with the event.

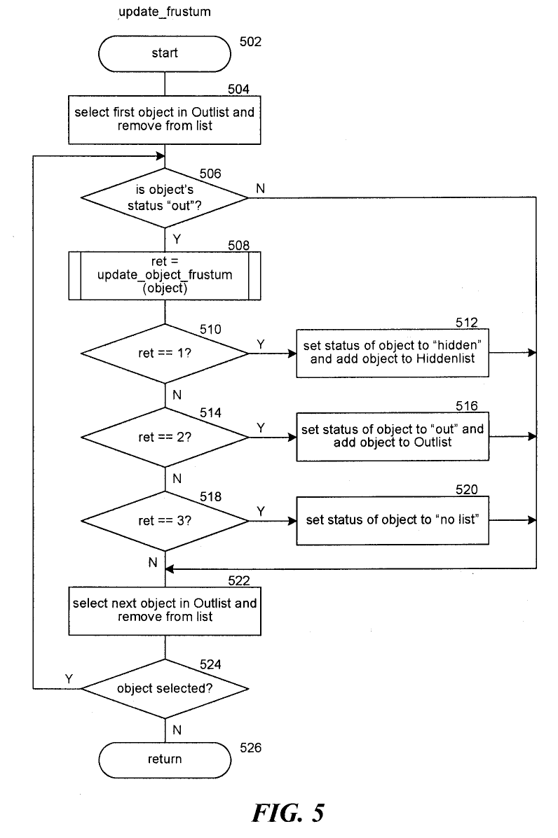

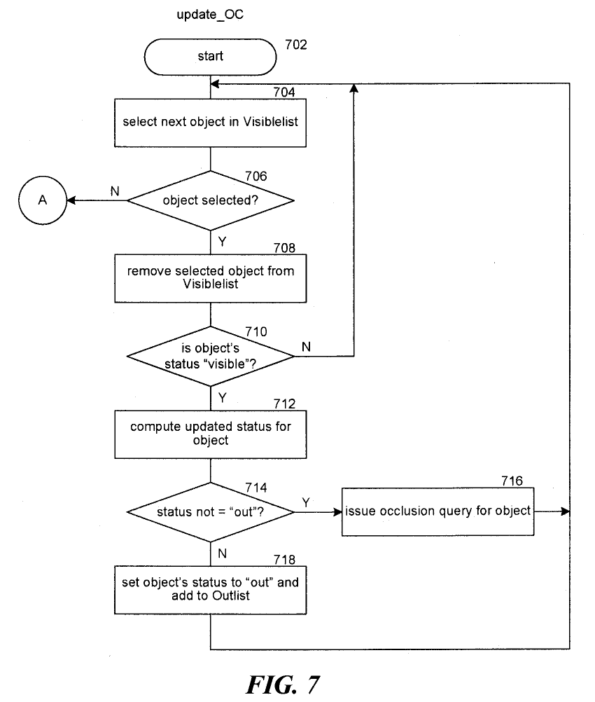

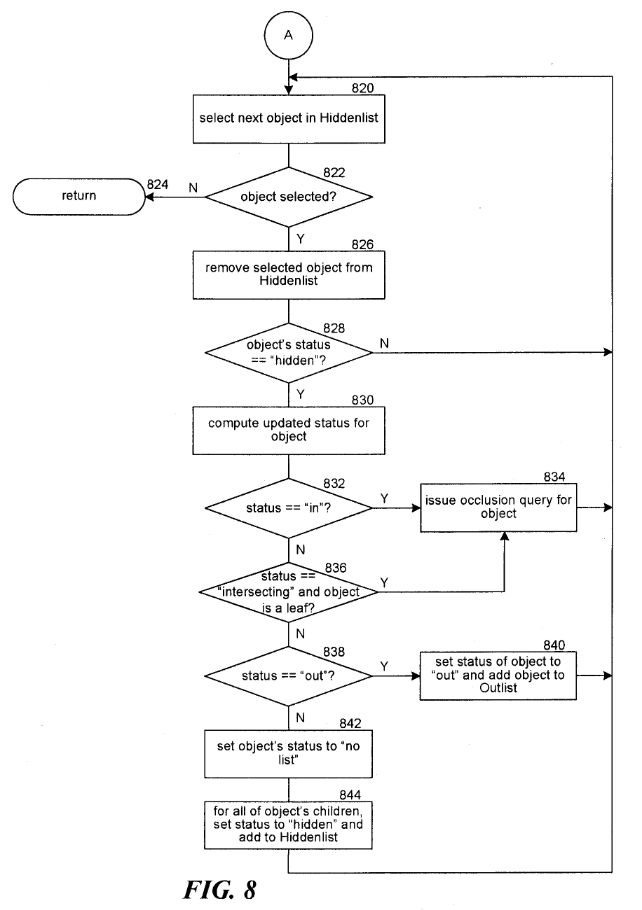

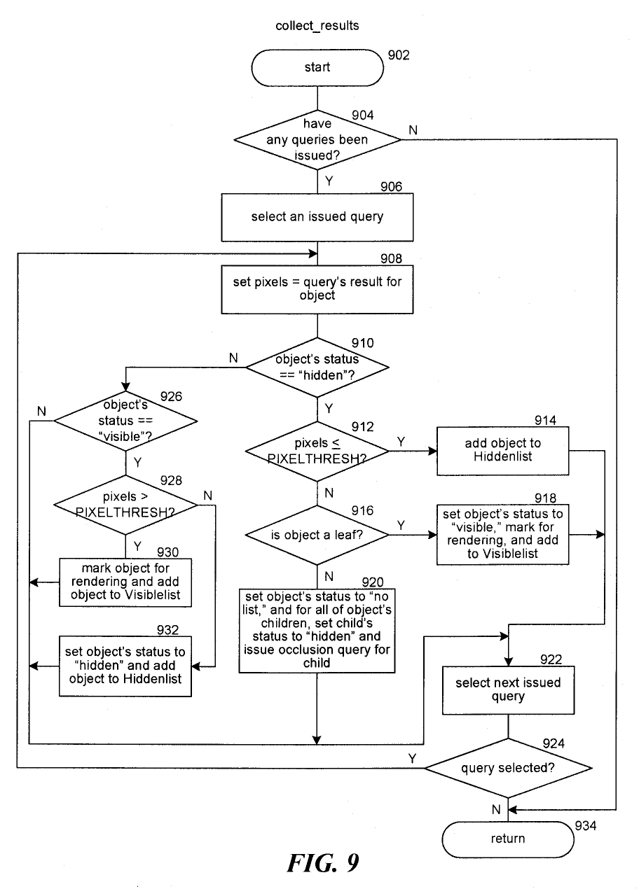

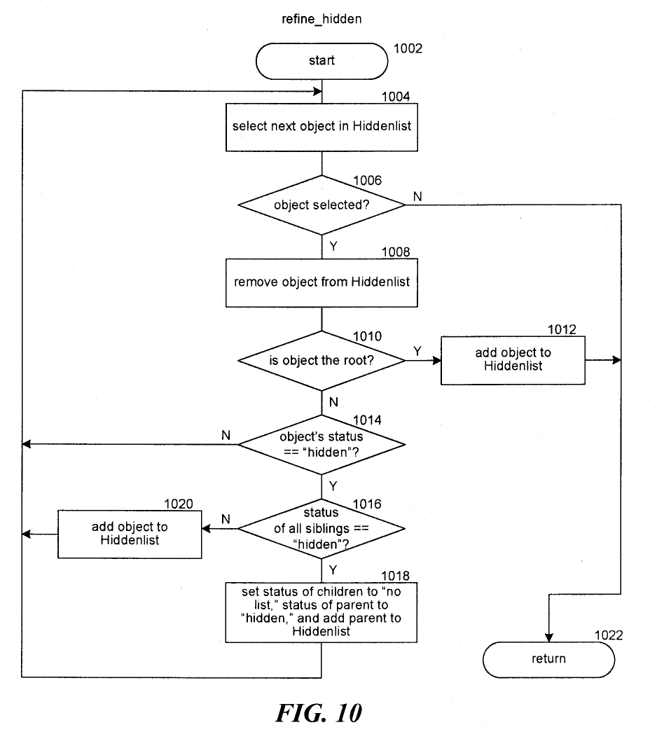

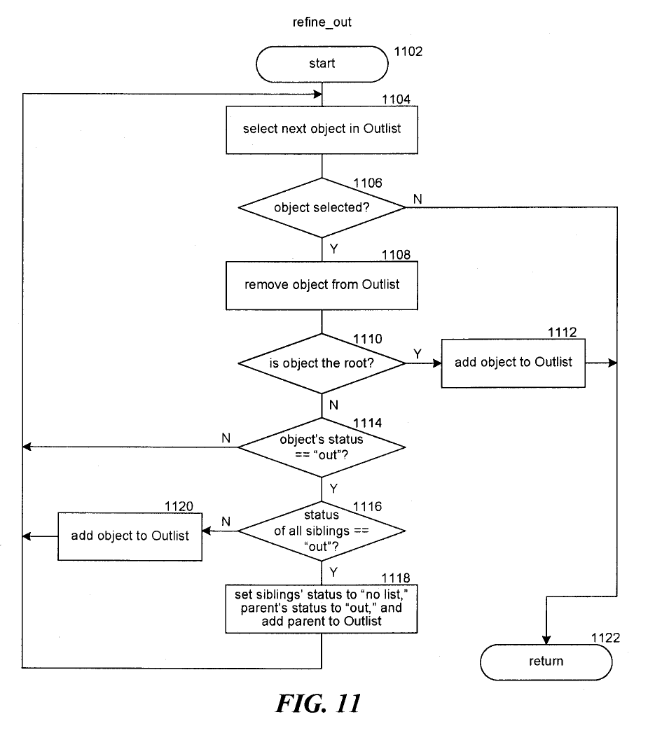

At block 312, the routine invokes an update_frustum subroutine to update the frustum. The update_frustum subroutine is described in further detail below in relation to FIG. 5. At block 314, the routine invokes an update_OC. subroutine. The update_OC. subroutine is described in further detail below in relation to FIGS. 7 and 8. At block 316, the routine invokes a collect_results subroutine. The collect_results subroutine is described in further detail below in relation to FIG. 9. At block 318, the routine invokes a refine_hidden subroutine. The refine_hidden subroutine is described in further detail below in relation to FIG. 10. At block 320, the routine invokes a refine_out subroutine. The refine_out subroutine is described in further detail below in relation to FIG. 11. The routine then continues at decision block 304.

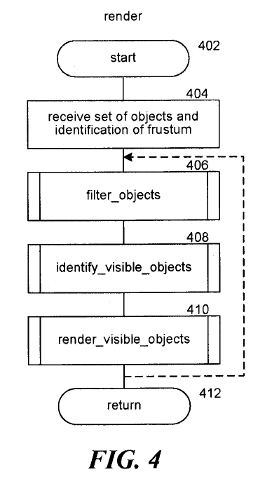

FIG. 4 is a flow diagram illustrating a render routine invoked by the occlusion culling system in some embodiments. The occlusion culling system can invoke the render routine to render (e.g., display or print) objects, such as on a display screen. The routine begins at block 402. At block 404, the routine receives a set of objects and an identification of a frustum. At block 406, the routine invokes a filter_objects routine to identify objects that need to be analyzed, such as for display. As an example, the subroutine may filter out from analysis objects that do not appear in the frustum. At block 408, the subroutine identifies visible objects by invoking a identify_visible_objects subroutine. The identify_visible_objects subroutine may identify objects based on whether the objects are occluded. At block 410, the routine renders the visible objects by invoking a render_visible_objects subroutine. The routine may then continue at block 406, such as when the occlusion culling system is employed with an application that displays animations. At block 412, the routine returns.

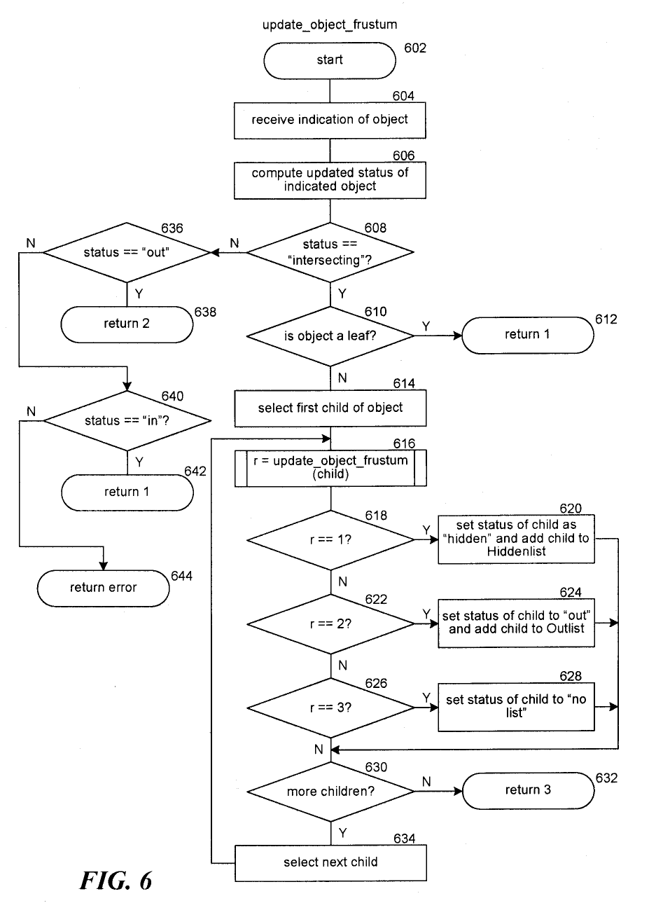

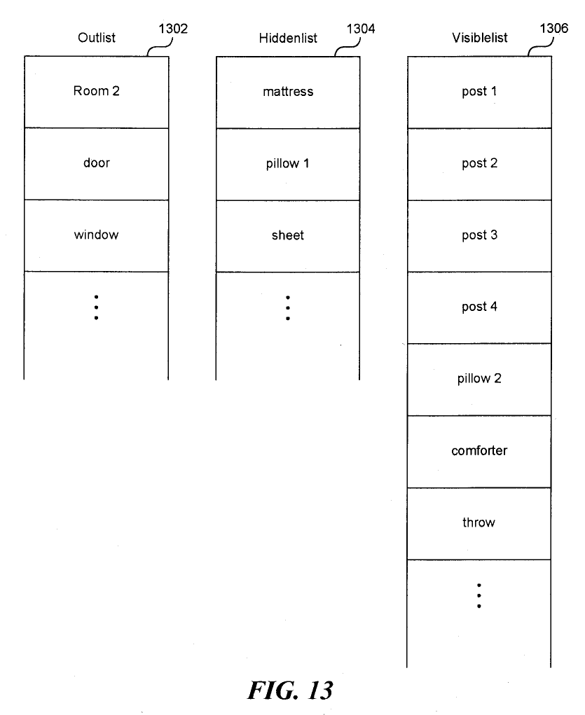

FIGS. 5-6 illustrate routines for handling objects in relation to the view frustum. In various embodiments, the occlusion culling system divides objects (e.g., associated with nodes of the hierarchical tree) into three lists: Outlist, Hiddenlist, and Visiblelist. The Outlist contains objects that are outside the view frustum; the Hiddenlist contains objects that are inside the view frustum, but are occluded; and the Visiblelist contains objects that are inside the view frustum and visible. The lists can be implemented as arrays, stacks, queues, linked lists, or other data structures. These lists are described in further detail below in relation to FIG. 13.

FIG. 5 is a flow diagram illustrating an update_frustum routine invoked by the occlusion culling system in some embodiments. The occlusion culling system invokes the update_frustum routine to determine whether objects are inside or outside the view frustum. The routine begins at block 502. At block 504, the routine selects the first object in the Outlist and removes the selected object from the list. At decision block 506, the routine determines whether the selected object's status is “out.” An object's status can be “out” when it is outside the view frustum. If the object's status is “out,” the routine continues at block 508. Otherwise, the routine continues at block 522. At block 508, the routine sets a variable “ret” to the result provided by invoking an update_object_frustum subroutine. The update_object_frustum subroutine is described in further detail below in relation to FIG. 6. In some embodiments, the routine may provide an indication of the object to the update_object_frustum subroutine, such as by providing a parameter. At decision block 510, the routine determines whether the value returned by the update_object_frustum subroutine is 1. If that is the case, the routine continues at block 512. Otherwise, the routine continues at decision block 514. At block 512, the routine sets the status of the object to “hidden” and adds the object to the Hiddenlist. An object's status can be “hidden” when it is occluded by other objects in the model. The routine then continues at block 522.

At decision block 514, the routine determines whether the value returned by the update_object_frustum subroutine is 2. If that is the case, the routine continues at block 516. Otherwise, the routine continues at decision block 518. At block 516, the routine sets the status of the object to “out” and adds the selected object to the Outlist. The routine then continues at block 522.

At decision block 518, the routine determines whether the value returned by the update_object_frustum subroutine is 3. If that is the case, the routine continues at block 520. Otherwise, the routine continues at block 522. At block 520, the routine sets the status of the object to “no list.” The routine then continues at block 522.

At block 522, the routine selects the next object in the Outlist and removes the selected object from the list. At decision block 524, the routine determines whether an object was selected at block 522. If an object was selected, the routine continues at block 506. Otherwise, the routine returns at block 526.

FIG. 6 is a flow diagram illustrating an update_object_frustum routine invoked by the occlusion culling system in some embodiments. The update_object_frustum routine can be invoked by the update_frustum routine. The routine begins at block 602.

At block 604, the routine receives an indication of an object. At block 606, the routine computes an updated status for the indicated object. As an example, the routine determines whether the object is inside the frustum, outside the frustum, or intersects the frustum. The routine can make this computation through mathematical or geometric transformations.

At decision block 608, the routine determines whether the object's status is intersecting. If that is the case, the routine continues at decision block 610. Otherwise, the routine continues at decision block 636.

At block 610, the routine determines whether the object is a leaf. If that is the case, the routine returns a value of 1 at block 612. Otherwise, the routine selects the first child of the indicated object at block 614.

At block 616, the routine sets a variable “r” to the value returned by a recursive invocation of the update_object frustum routine and provides subroutine the child of the indicated object as a parameter.

At decision block 618, the routine determines whether the variable r is 1. If that is the case, the routine continues at block 620. Otherwise, the routine continues at decision block 622. At block 620, the routine sets the status of the child as “hidden” and adds the child to the Hiddenlist. The routine then continues at decision block 630.

At decision block 622, the routine determines whether the variable “r” is set to 2. If that is the case, the routine continues at block 624. Otherwise, the routine continues at decision block 626. At block 624, the routine sets the status of the child to “out” and adds the child to the Outlist. The routine then continues at decision block 630.

At decision block 626, the routine determines whether the variable “r” is 3. If that is the case, the routine continues at block 628. Otherwise, the routine continues at decision block 630. At block 628, the routine sets the status of the child to “no list.” The routine then continues at decision block 630.

At decision block 630, the routine determines whether the indicated object has more children. If the indicated object has no more children, the routine returns 3 at block 632. Otherwise, the routine selects the next child at block 634 and then continues at block 616.

At decision block 636, the routine determines whether the status of the indicated object is “out.” If that is the case, the routine returns 2 at block 638. Otherwise, the routine continues at decision block 640.

At decision block 640, the routine determines whether the status of the indicated object is “in.” If that is the case, the routine returns 1 at block 642. Otherwise, the routine returns an error at block 644 because the status could not be determined to be “in” or “out” even though the object does not intersect the view frustum.

FIGS. 7-8 are flow diagrams illustrating an update_OC routine invoked by the occlusion culling system in some embodiments. The update_OC. routine processes the Visiblelist (see, e.g., FIG. 7) and the Hiddenlist (see, e.g., FIG. 8).

The routine begins at block 702. At block 704, the routine selects the next object in the Visiblelist. At decision block 706, the routine determines whether an object was selected. As an example, when all objects in the Visiblelist have been processed, no more objects will be selectable. If an object was selected, the routine continues at block 708. Otherwise, the routine continues at block 820 of FIG. 8 (illustrated via connector “A”).

At block 708, the routine removes the selected object from the Visiblelist. At decision block 710, the routine determines whether the object's status is set to “visible.” If that is the case, the routine continues at block 712. Otherwise, the routine continues at block 704 where it selects another object from the Visiblelist.

At block 712, the routine computes an updated status for the object. As an example, the routine determines whether the object is inside, outside, or intersects the frustum. The routine can make this computation through mathematical or geometric transformations. At decision block 714, the routine evaluates the updated status. If the status for the object is not “out,” the routine continues at block 716. Otherwise, the routine continues at block 718. When processing the Visiblelist, the occlusion culling system treats all objects not outside the view frustum as having equivalent status because the Visiblelist only has leaf nodes in some embodiments and so analysis of descendant nodes may not be possible.

At block 716, the routine issues an occlusion query for the object. As an example, the routine invokes a function provided by a GPU for determining whether an object is occluded by another object.

In some embodiments, the occlusion culling system issues occlusion queries based on the result of a previous frame's depth buffer instead of re-rendering all objects in the frustum as an optimization. Although issuing occlusion queries based on all objects in the view frustum would be more accurate, it could be considerably slower when many objects need to be analyzed. When the relative movement of a dynamic object is large, the occlusion culling system may issue occlusion queries for the dynamic object or all objects in the frame.

At block 718, the routine sets the object's status to “out” and adds the object to the Outlist. After completing the logic represented by blocks 716 and 718, the routine continues at block 704, where it selects another object from the Visiblelist.

Referring now to FIG. 8, the routine continues at block 820 if an object was not selected at decision block 706 of FIG. 7. At block 820, the routine selects the next object in the Hiddenlist.

At decision block 822, the routine determines whether an object was selected from the Hiddenlist. Thus, the routine determines whether all objects from the Hiddenlist have already been processed. If an object could not be selected from the Hiddenlist, the routine returns at block 824. Otherwise, if an object was selected, the routine continues at block 826.

At block 826, the routine removes the selected object from the Hiddenlist. At decision block 828, the routine determines whether the object's status is set to “hidden.” If it is not set to “hidden,” the routine continues at block 820, where it selects another object from the Hiddenlist. Otherwise, if the object's status is set to “hidden,” the routine continues at block 830.

At block 830, the routine computes an updated status for the object. As an example, the routine determines whether the object presently is inside the frustum, outside the frustum, or intersects the frustum.

At decision block 832, the routine determines whether the object's status is set to “in.” If that is the case, the routine continues at block 834, where it issues an occlusion query for the object. As an example, the routine issues the occlusion query to a GPU. Upon completion of the logic represented by block 834, the routine continues at block 820, where it selects another object from the Hiddenlist. If the status of the object is not set to “in,” the routine continues at decision block 836.

At decision block 836, the routine determines whether the status for the object is “intersecting” and whether the object is a leaf. If both of those conditions are true, the routine continues at block 834. Otherwise, the routine continues at decision block 838.

At decision block 838, the routine determines whether the object's status is “out.” If that is the case, the routine continues at block 840. Otherwise, the routine continues at block 842.

At block 840, the routine sets the status of the object to “out” and adds the object to the Outlist. The routine then continues at block 820, where it selects another object from the Hiddenlist.

At block 842, the routine sets the object's status to “no list.” At block 844, the routine sets the status for all the object's children to “hidden” and adds the children to the Hiddenlist. The routine then continues at block 820, where it selects another object from the Hiddenlist.

When an object's status is “intersecting” and the object is not associated with a leaf node, the occlusion culling system moves the visibility cut to a layer of the hierarchy below the node associated with the object (e.g., to the node's children). The children are added to the Hiddenlist so that they are subsequently processed by the routine.

FIG. 9 is a flow diagram illustrating a collect_results routine invoked by the occlusion culling system in some embodiments. The occlusion culling system invokes the collect_results routine to process the results of occlusion queries that were previously issued. By issuing new occlusion queries to the GPU and processing the results of previously issued occlusion queries with the CPU, both processing units can be occupied in parallel, thereby improving performance. The routine begins at block 902.

At decision block 904, the routine determines whether any occlusion queries have been issued. The occlusion culling system may track the number of occlusion queries it issues or it may request this information from the GPU. If at least one occlusion query has been issued, the routine continues at block 906. Otherwise, the routine returns at block 934.

At block 906, the routine selects one of the issued occlusion queries. As an example, the routine requests the results of the selected query from a GPU. At block 908, the routine sets a variable “pixels” to the result for the occlusion query selected at block 906. Generally, each occlusion query relates to an object. Thus, the result for the occlusion query relates to an object. In various embodiments, the result from the occlusion query is the number of pixels that are visible or occluded.

At decision block 910, the routine determines whether the object's status is set to “hidden.” An object can be “hidden” when none of its pixels is visible. If the object is hidden, the routine continues at decision block 912. Otherwise, when the object is not hidden, the routine continues at decision block 926.

At decision block 912, the routine determines whether the value that was assigned to the “pixels” variable is less than or equal to a threshold number of pixels (“PIXELTHRESH”). If the number of pixels is less than or equal to the threshold, the routine continues at block 914. Otherwise, the routine continues at decision block 916.

In various embodiments, the occlusion culling system prevents objects displaying less than the threshold number of pixels from displaying at all. Increasing this threshold would increase performance because additional objects are classified as hidden and so fewer computations need to be performed, but fewer details of the scene may be rendered as a result.

At block 914, the routine adds the object to the Hiddenlist. Thus, when an object's status is hidden or the number of pixels that is visible is less than or equal to a specified threshold value, the object is treated as being hidden. Upon completion of the logic represented by block 914, the routine continues at block 922.

At decision block 916, the routine determines whether the node associated with the object is a leaf node. If the node is a leaf node, the routine continues at block 918. Otherwise, the routine continues at block 920.

When an object is associated with a leaf node, it is to be rendered. Thus, at block 918, the routine sets the object's status to “visible,” marks it for rendering, and adds the object to the Visiblelist. The routine then continues at block 922.

At block 920, because the object is not associated with a leaf node, the routine sets the object's status to “no list.” The routine takes this action because non-leaf nodes may not contain geometries used to render objects. The routine also sets the status of all the object's children to “hidden” and issues an occlusion query for each child. Children of nodes will be inside the view frustum because their parent was completely inside the view frustum. The routine then continues at block 922.

At block 922, the routine selects the next issued occlusion query. At decision block 924, the routine determines whether a query was selected. As an example, when all issued occlusion queries have been processed, another query may not be selectable. If another query could not be selected, the routine continues at block 934, where it returns. Otherwise, the routine continues at block 908.

At decision block 926, the routine determines whether the object's status is “visible.” If that is the case, the routine continues at decision block 928. Otherwise, the routine continues at block 922.

At decision block 928, the routine determines whether the variable “pixels” contains a value that is greater than the “PIXELTHRESH” threshold value. If that is the case, the routine continues at block 930. Otherwise, the routine continues at block 932.

At block 930, the routine marks the object for rendering and adds the object to the Visiblelist. The routine then continues at block 922.

At block 932, the routine sets the object's status to “hidden” and adds the object to the Hiddenlist. The routine then continues at block 922.

FIG. 10 is a flow diagram illustrating a refine_hidden routine invoked by the occlusion culling system in some embodiments. The routine begins at block 1002.

At block 1004, the routine selects the next object in the Hiddenlist. At decision block 1006, the routine determines whether an object was selected. As an example, when all objects have been processed, another object may not be selected. If an object was selected, the routine continues at block 1008. Otherwise the routine continues at block 1022, where it returns.

At block 1008, the routine removes the selected object from the Hiddenlist. At decision block 1010, the routine determines whether the selected object is the root of the tree of objects. If the object is the root, the routine continues at block 1012. Otherwise, the routine continues at decision block 1014.

At block 1012, the routine adds the selected object to the Hiddenlist. The routine then continues at block 1022, where it returns.

At decision block 1014, the routine determines whether the object's status is set to “hidden.” If that is the case, the routine continues at decision block 1016. Otherwise, the routine continues at block 1004.

At decision block 1016, the routine determines whether the status of all the selected object's children is “hidden.” If that is the case, the routine continues at block 1018. Otherwise, the routine continues at block 1020.

At block 1018, the routine sets the status of the object's children to “no list,” sets the status of the object's parent to “hidden,” and adds the object's parent to the Hiddenlist. The routine then continues at block 1004.

At block 1020, the routine adds the selected object to the Hiddenlist. The routine then continues at block 1004.

FIG. 11 is a flow diagram illustrating a refine_out routine invoked by the occlusion culling system in some embodiments. The routine begins at block 1102.

At block 1104, the routine selects the next object in the Outlist. At decision block 1106, the routine determines whether an object was selected. As an example, when all objects in the Outlist have been processed, another object may not be select. If an object was selected, the routine continues at block 1108. Otherwise, the routine continues at block 1122, where it returns.

At block 1108, the routine removes the selected object from the Outlist. At decision block 1110, the routine determines whether the selected object is the root of the tree of objects. If the object is the root, the routine continues at block 1112. Otherwise, the routine continues at decision block 1114.

At block 1112, the routine adds the selected object to the Outlist. The routine then continues at block 1122, where it returns.

At decision block 1114, the routine determines whether the object's status is set to “out.” If that is the case, the routine continues at decision block 1116. Otherwise, the routine continues at block 1104.

At decision block 1116, the routine determines whether the status of all the selected object's siblings is “out.” If that is the case, the routine continues at block 1118. Otherwise, the routine continues at block 1120.

At block 1118, the routine sets the siblings' status to “no list,” sets the parent's status to “out,” and adds the parent to the Outlist.

At block 1120, the routine adds the selected object to the Outlist. The routine then continues at block 1104.

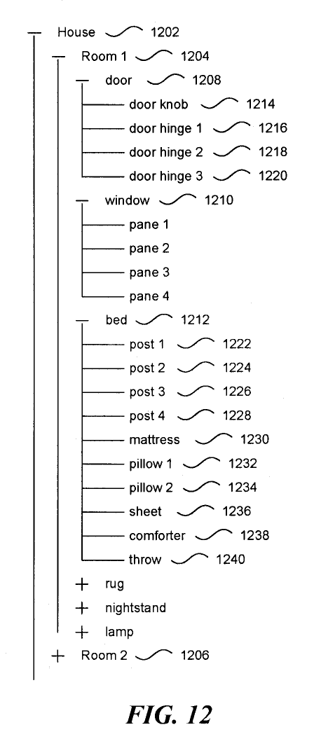

FIG. 12 is a data diagram illustrating a hierarchical representation of data the occlusion culling system may employ in some embodiments. The hierarchical representation can be internally represented as, for example, a tree. Alternate data structures were also possible. The hierarchical data structure illustrated in FIG. 12 relates to objects in a house. The root node 1202 represents the house. The house contains at least two rooms 1204 and 1206. Room 1204 is further divided into a door 1208, a window 1210, and a bed 1212. Each of these objects can be further divided. As an example, the door 1208 is divided into a doorknob 1214, and door hinges 1216-1220. The window 1210 is divided into multiple window panes. The bed 1212 is divided into bed posts 1222-1228, a mattress 1230, pillows 1232-1234, a sheet 1236, a comforter 1238, and a throw 1240. Some of these objects may be occluded by other objects when the objects are rendered. As an example, the comforter 1238 may occlude at least a portion of a mattress 1230.

FIG. 13 is a data diagram illustrating lists the occlusion culling system may employ in some embodiments. The figure illustrates an Outlist 1302, a Hiddenlist 1304, and a Visiblelist 1306. Each of these lists contains an indication of an object, such as an object in the hierarchical representation illustrated in FIG. 12. In various embodiments, the Outlist may include pointers to objects that are not in the view frustum, the Hiddenlist may include pointers to objects that are presently hidden, and the Visiblelist may include pointers to objects that are visible.

Although the occlusion culling system generally issues occlusion queries that are handled by one or more GPUs, the occlusion queries can also be handled by other processors or devices.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Accordingly, the invention is not limited except as by the appended claims.

We claim:

1. A method performed by a computing system for reducing occlusion queries when displaying multiple objects, comprising:
receiving a set of objects, the set of objects associated with nodes in a hierarchical tree data structure and together defining a model, each object defining a portion of the model and identified by a set of coordinates associated with an object space;
receiving an indication of a view frustum, the view frustum identifying a region of a three-dimensional coordinate system into which the objects are transformed;
determining whether a specified object of the set of objects is within the view frustum, the determining comprising:
computing whether the specified object is within the view frustum, outside the view frustum, or intersects the view frustum; and
when the object intersects the view frustum,
adding the specified object to a list of hidden objects when the specified object is associated with a leaf node of the hierarchical tree data structure, and
recursively adding children of the node associated with the specified object that intersects the view frustum to the list of hidden objects when the children are associated with leaf nodes of the hierarchical tree data structure; when the specified object is inside the view frustum after previously being hidden, issuing an occlusion query for the specified object; and
when a result of the occlusion query indicates that greater than a threshold number of pixels will be displayed for the specified object, causing the specified object to be rendered.

2. The method of claim 1 wherein the recursively adding further comprises:
adding a second object associated with a child node of the specified object to a list of objects that are outside the view frustum when the second object does not intersect the view frustum and is computed to be outside the view frustum.

3. The method of claim 1 wherein the recursively adding further comprises:
adding a second object associated with a child node of the specified object to a list of hidden objects when the second object does not intersect the view frustum but is inside the view frustum.

4. The method of claim 1 further comprising:
updating a time bounding volume for the specified object, the time bounding volume indicating a time at or after which the specified object should be analyzed again prior to rendering; and
scheduling an event relating to the specified object, the event causing the specified object to be analyzed again prior to rendering and scheduled upon the expiry of the time bounding volume.

5. The method of claim 1 wherein the occlusion query is performed by a hardware graphics processing unit.

6. The method of claim 1 further comprising issuing an occlusion query when the specified object is inside the view frustum after previously being hidden.

7. The method of claim 1 further comprising issuing an occlusion query when the specified object is associated with a leaf node of the hierarchical tree data structure and intersects the view frustum after previously being hidden.

8. The method of claim 1 further comprising causing the specified object to be rendered when the result of the occlusion query indicates that greater than a threshold number of pixels will be displayed for the specified object and the specified object is associated with a leaf node of the hierarchical tree data structure.

9. The method of claim 1 further comprising adding the specified object to a list of hidden objects when the result of the occlusion query indicates that greater than a threshold number of pixels will not be displayed for the specified object.

10. The method of claim 1 further comprising refining a list of hidden objects by performing an occlusion refinement wherein a second object is marked as hidden when all children nodes of the node associated with the second object are marked as hidden.

11. The method of claim 1 further comprising refining a list of objects that are outside the view frustum by performing a frustum refinement wherein a parent node of a node associated with a second object is marked as being outside the view frustum when the second node's sibling nodes are marked as being outside the view frustum.

12. A system for reducing occlusion queries when displaying multiple objects, comprising:
a set of modeling information that describes a geometric model of a group of objects that can be displayed;
a transformation component that receives the set of modeling information and a selection of a viewing frustum, the viewing frustum establishing a subset of the set of modeling information that is to be displayed;
a graphics processing unit that efficiently handles occlusion queries wherein an occlusion query identifies an object and the graphics processing unit provides an indication of a number of pixels that correspond to rendering the object; and
an occlusion culling component that identifies an occlusion query to issue to the graphics processing unit based at least on whether the object was previously visible and is presently not outside the viewing frustum so that the graphics processing unit can provide an indication of whether the object is to be rendered.

13. The system of claim 12 wherein the occlusion culling component identifies the occlusion query to issue to the graphics processing unit based on whether the object presently intersects the viewing frustum.

14. The system of claim 12 wherein the occlusion culling component identifies the occlusion query to issue to the graphics processing unit based additionally on whether the object was previously hidden and is presently inside the viewing frustum.

15. The system of claim 12 wherein the occlusion culling component identifies the occlusion query to issue to the graphics processing unit based additionally on whether the object was previously hidden, presently intersects the viewing frustum, and is associated with a leaf node of a hierarchical tree data structure corresponding to the set of modeling information.

16. The system of claim 12 wherein the occlusion culling component issues the occlusion query to the graphics processing unit when analyzing a list of visible objects.

17. The system of claim 12 wherein the occlusion culling component issues the occlusion query to the graphics processing unit when analyzing a list of hidden objects that are now visible.

18. A computer-readable medium storing computer-executable instructions that, when executed, cause a computing system to perform a method for reducing occlusion queries when displaying multiple objects, the method comprising:
updating motion parameters relating to an object;
determining whether a flag has been set indicating that the object has moved but has not yet been analyzed after the movement;
when the flag has not been set,
updating a time bounding volume for the object;
scheduling an event, the event indicating a time at or after which to analyze the object; and
issuing an occlusion query for the object when the analysis indicates that a status for the object was previously visible and is presently not outside a viewing frustum.

19. The computer-readable medium of claim 18 further comprising updating the time bounding volume and unsetting the flag at or after the indicated time.

20. The computer-readable medium of claim 18 further comprising updating the viewing frustum and rendering the object.
